(19) United States
(12) Patent Application Publication
(10) Pub. No.: US 2010/0067721 A1
(43) Pub. Date: Mar. 18, 2010

(54) Hearing device and operation of a hearing device with frequency transposition

(76) Inventor: Andreas Tiefenau, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/555,835

(22) Filed: Sep. 9, 2009

(30) Foreign Application Priority Data
Sep. 12, 2008 (DE) 10 2008 046 966.1

(51) Int. Cl. H04R 25/00

(52) U.S. Cl. 381/313

(57) ABSTRACT

The invention specifies a method for the operation of a hearing device and an associated hearing device with at least two omnidirectional microphones emitting microphone signals. Said microphones are connected electrically to one another in order to form a signal with directional characteristic. Signal components of the signal with directional characteristic above a cut-off frequency are transposed or compressed down to a frequency range below the cut-off frequency. Here it is advantageous that a frequency transposition can only be applied to useful signals, since the directional microphone system suppresses background noises such that these are not transposed down to a low frequency range.

### CROSS REFERENCE TO RELATED APPLICATIONS

This application claims priority of German application No. 10 2008 046 966.1 filed Sep. 12, 2008, which is incorporated by reference herein in its entirety.

### FIELD OF THE INVENTION

The invention relates to a method for the operation of a hearing device with at least two omnidirectional microphones emitting microphone signals, with said microphones being connected electrically to one another in order to form a signal with directional characteristic.

### BACKGROUND OF THE INVENTION

Hearing devices are wearable hearing apparatuses which are used to assist the hard-of-hearing. In order to accommodate numerous individual requirements, various types of hearing devices are available such as behind-the-ear hearing devices, hearing device with external receiver and in-the-ear (ITE) hearing devices, for example also concha hearing devices or completely-in-the-canal hearing devices. The hearing devices listed as examples are worn on the outer ear or in the auditory canal. Bone conduction hearing aids, implantable or vibrotactile hearing aids are also available on the market. The damaged hearing is thus stimulated either mechanically or electrically.

The key components of hearing devices are principally an input converter, an amplifier and an output converter. The input converter is normally a receiving transducer e.g. a microphone and/or an electromagnetic receiver, e.g. an induction coil. The output converter is most frequently realized as an electroacoustic converter e.g. a miniature loudspeaker, or as an electromechanical converter e.g. a bone conduction hearing aid. The amplifier is usually integrated into a signal processing unit. This basic configuration is illustrated in FIG. 1 using the example of a behind-the-ear hearing device. One or a plurality of microphones 2 for recording ambient sound are built into a hearing device housing 1 to be worn behind the ear. A signal processing unit 3 which is also integrated into the hearing device housing 1 processes and amplifies the microphone signals. The output signal for the signal processing unit 3 is transmitted to a loudspeaker or receiver 4, which outputs an acoustic signal. Sound is transmitted through a sound tube, which is affixed in the auditory canal by means of an otoplastic, to the device wearer's eardrum. Power for the hearing device and in particular for the signal processing unit 3 is supplied by means of a battery 5 which is also integrated in the hearing device housing 1.

In the case of binaural hearing impairment it makes sense to use one hearing device for each ear, since the quality of hearing is improved considerably by hearing with both ears compared to hearing with just one ear. In most cases there is different hearing loss in each ear and so the required two hearing devices have different settings.

Hearing impairment or hearing loss can have different causes and accordingly requires a hearing device that is attuned or adjusted to the particular cause of the hearing loss or hearing impairment. One widespread problem suffered by many hard-of-hearing people is high frequency hearing loss. High frequency hearing loss has a physiological cause. In the cochlea, mechanical vibrations caused by sound are transduced by the so-called hair cells into electrical energy, which is then conducted to the brain as a nerve impulse for further processing. In high frequency hearing loss this process is disturbed, because the areas in which higher frequencies are transduced into electrical energy only have few or no hair cells left. This sometimes leads to so-called “dead zones”, which are frequency ranges in which no mechanical energy whatsoever can be transformed into electrical energy.

It is difficult to provide optimal assistance with hearing devices for hard-of-hearing people suffering this type of hearing loss, since amplification of the sound signal in these frequency ranges does not help. An attempt is therefore made to transform the frequency ranges concerned such that they are transposed down to a lower frequency range in which hair cells are still available for sound transduction. In known solutions this problem is solved by means of signal processing. Hearing devices of this type have a signal processing system that uses a computer to transpose sound waves recorded by a microphone into a different frequency range and then outputs those signals to a receiver again as a lower signal. Thus the high-frequency components of the input signal are displaced to a low frequency range by means of signal processing in order to trigger a response in those areas of the basilar membrane and/or hair cells that are still active.

The patent specification US 2004/0175010 A1 specifies a hearing device and a method for the operation of the hearing device with a frequency transposition of microphone signals. The transposition is defined by a non-linear frequency transposition function.

In order to suppress background noise better, directional microphones are used in hearing devices. These are shown to improve speech intelligibility in hearing situations in which the useful signal and the noise signals are received from different directions. In modern hearing devices the directional effect is produced by differential processing of two or more adjacent microphones with omnidirectional characteristic.

FIG. 2 shows a simplified block diagram of a directional microphone system in the first arrangement with two microphones 11, 12 at a distance of around 10 to 15 mm. For sound signals arriving from the front V this causes an external delay of T2 between the first and the second microphone, which corresponds for example to the distance from the microphones 11, 12 to one another. The signal R2 from the second microphone 12 is delayed by time T1 in the delay unit 13, inverted in the inverter 14 and added in the first adder 5 to the signal R1 from the first microphone 11. The sum yields the directional microphone signal RA that can be fed via a signal processing function to a receiver for example. The directional sensitivity essentially results from a subtraction of the second microphone signal R2, which was delayed by time T2, from the first signal R1. Thus after appropriate equalization, sound signals from the front V are not attenuated, whereas sound signals from the rear S, for example, are canceled out. The structure and mode of operation of directional microphone systems for hearing devices are described for example in the patent specification DE 103 31 956 B3.

One disadvantage of directional microphone systems compared with omnidirectional microphones is that hearing devices generally have a lower stability threshold when the directional microphones are switched on than when operated with just one omnidirectional microphone, and the maximum possible signal amplification has to be reduced. In the case of severe hearing losses, directional microphones consequently cannot always be used at the requisite level of amplification.

### SUMMARY OF THE INVENTION

The object of the present invention is to provide a method for the operation of a hearing device, and a hearing device, that allow for better assistance of hearing device wearers, in particular with directional characteristic.

In accordance with the invention the object set is achieved with the method and the apparatus of independent claims.

The invention claims a method for the operation of a hearing device with at least two omnidirectional microphones emitting microphone signals, with said microphones being connected electrically to one another in order to form a signal with directional characteristic. Signal components of the signal with directional characteristic above a cut-off frequency are transposed and/or compressed down to a frequency range below the cut-off frequency. Since the hearing loss is less severe for many hearing device wearers at lower frequencies, it is possible to work with a lower amplification of the signal. It is also advantageous that a frequency transposition can only be applied to useful signals, since the directional microphone system suppresses background noise such that it is not transposed down to a low frequency range.

In a further embodiment the transposed and/or compressed signal components can be added to the signal with directional characteristic before its final amplification.

In a development the transposed and/or compressed signal components can be added to at least one omnidirectional microphone signal before its final amplification.

Advantageously the cut-off frequency can be the frequency at which the hearing curve of an audiogram attains the maximum compensatable hearing loss with a directional microphone mode.

The invention also specifies a hearing device with at least two omnidirectional microphones emitting microphone signals, with said microphones being connected electrically to one another, and to a signal processing unit, in order to form a signal with directional characteristic. The signal processing unit transposes and/or compresses signal components of the signal with directional characteristic above a cut-off frequency down to a frequency range below the cut-off frequency. The combination of background noise suppression by the directional microphone system and transposition of a useful signal down to frequencies with lower hearing loss is advantageous.

In a development the transposed and/or compressed signal components can be added to the signal with directional characteristic in an adder before its final amplification.

In a further embodiment the transposed and/or compressed signal components can be added to at least one omnidirectional microphone signal in an adder before its final amplification.

Advantageously the cut-off frequency can be determined in the signal processing unit, with the cut-off frequency being the frequency at which the hearing curve of an audiogram attains the maximum compensatable hearing loss with a directional microphone mode.

According to the invention a computer program product with a computer program is also specified, which has software means of performing a method according to the invention, when the computer program is executed in a control unit of a hearing device according to the invention.

### BRIEF DESCRIPTION OF THE DRAWINGS

Further specific features and advantages of the invention will be apparent from the following explanations of several exemplary embodiments with reference to schematic drawings, in which:

FIG. 1: shows a block diagram of a hearing device according to the prior art,

FIG. 2: shows a block diagram of a directional microphone according to the prior art,

FIG. 3: shows a block diagram of a signal processing function according to the invention,

FIG. 4: shows a block diagram of a further signal processing function according to the invention,

FIG. 5: shows an audiogram.

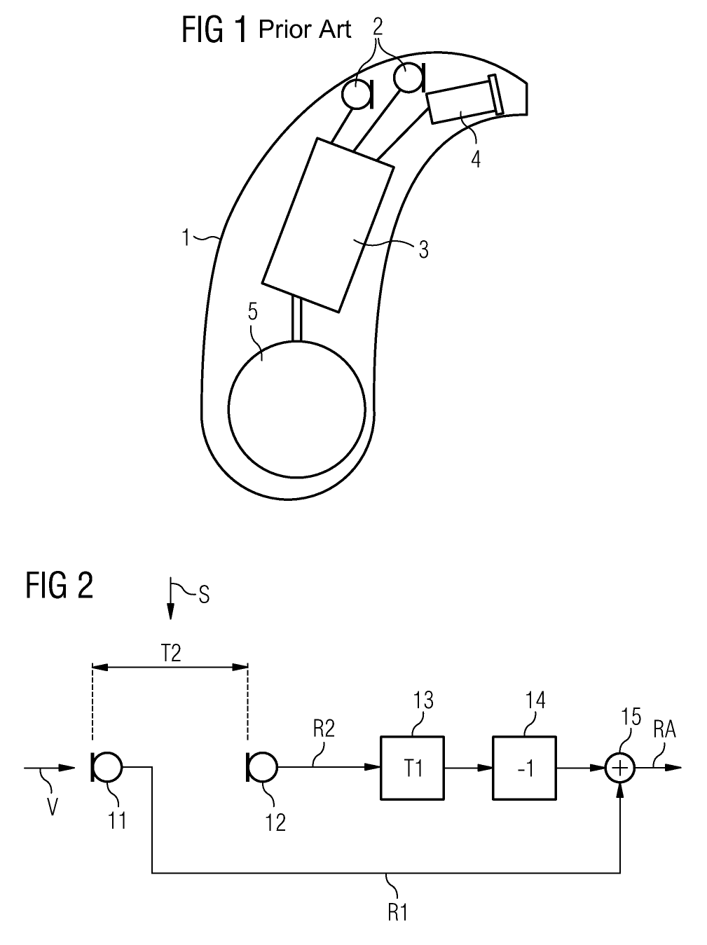

### DETAILED DESCRIPTION OF THE INVENTION

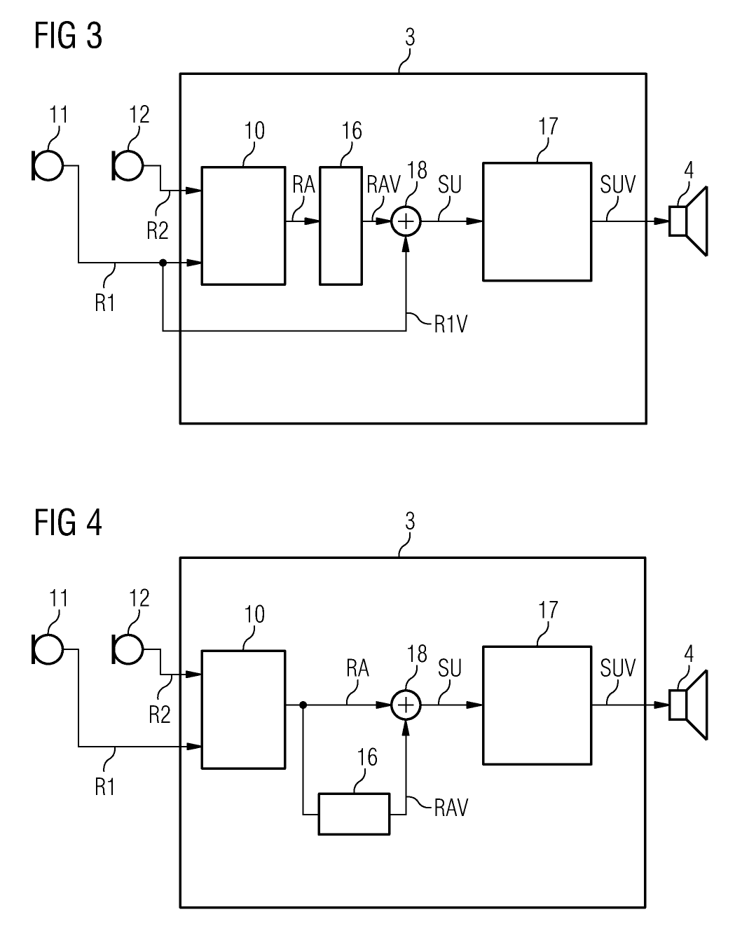

FIG. 3 shows a block diagram with the principal function blocks of a signal processing function according to the invention. Microphone signals R1, R2 are emitted by two omnidirectional microphones 11, 12. The microphone signals R1, R2 are fed to an input of a directional microphone unit 10. From the microphone signals R1, R2 that are connected to one another, the directional microphone unit 10 forms a signal with directional characteristic RA as illustrated in FIG. 2. The signal with directional characteristic arrives at an input of a frequency transposition unit 16, in which signals above a cut-off frequency GF are transposed or compressed down to low frequencies. A transposed signal with directional characteristic RAV is fed from an output of the frequency transposition unit 16 to an input of a second adder 18. The first microphone signal R1 also arrives at a further input of the adder 18. Both signals R1, RAV are combined in the second adder 18 and arrive from an output as a microphone sum signal SU at an input of a signal processing and amplification unit 17, in which the microphone sum signal SU is processed, modified and amplified according to an adjustable amplification. The amplified and processed microphone sum signal SUV arrives from an input of the signal processing and amplification unit 17 at an input of a loudspeaker 4. The loudspeaker 4 emits the frequency-transposed and/or compressed sound signal to the eardrum of a hearing device user. The directional microphone unit 10, the frequency transposition unit 16, the second adder 18 and the signal processing and amplification unit 17 form part of a signal processing unit 3.

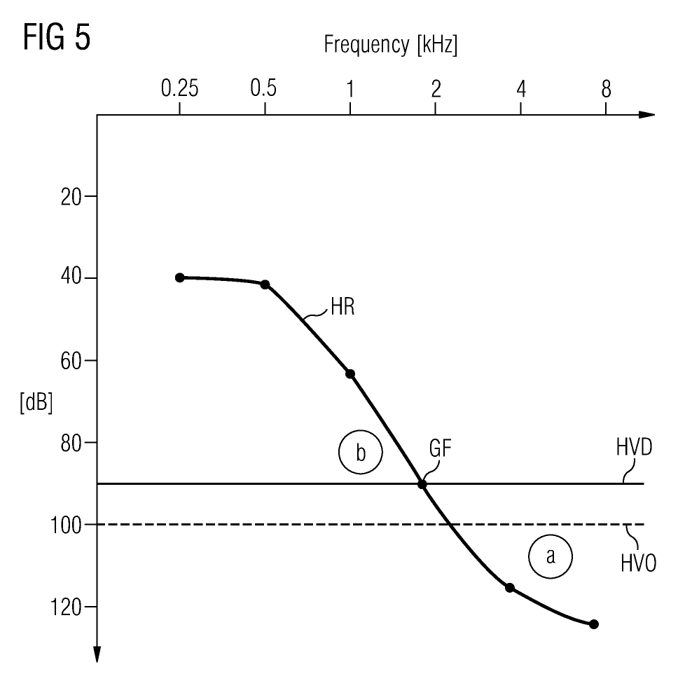

FIG. 4 shows a schematic representation of a further signal processing function according to the invention. FIG. 4 shows the principal function blocks consisting of microphones 11, 12 of a signal processing unit 3 and a receiver and/or loudspeaker 4. Within the signal processing unit 3 the microphone signals R1, R2 emitted by the microphones 11, 12 are processed in a directional microphone unit 10 into a signal with directional characteristic RA. On the one hand the signal with directional characteristic RA is fed to an input of a second adder 18. On the other hand the signal with directional characteristic RA above a cut-off frequency GF is transposed or compressed down to low frequencies by means of a frequency transposition unit 16. The signal RAV thus transposed arrives from an output of the frequency transposition unit 16 at a further input of the second adder 18. In the adder 18 the signal with directional characteristic RA and the frequency-transposed signal with directional characteristic RAV are summated and supplied to an output. From the output of the adder 18 a microphone sum signal SU arrives at an input of a signal processing and amplification unit 17, in which the microphone sum signal SU is processed and amplified according to an adjustable amplification. The microphone sum signal SUV amplified in this way is fed from an output of the signal processing and amplification unit 17 to an input of the receiver 4. The sound signal emitted by the receiver, which has been frequency-transposed and/or frequency-compressed, finally arrives at the eardrum of a hearing device user.

FIG. 5 shows a typical audiogram of a person with impaired hearing. The X axis of the audiogram coordinate system has as its unit frequency in kHz. The Y axis shows the sound pressure level relative to the normal hearing threshold of a person in dB. The continuous line HVD corresponds to a maximum possible hearing loss compensation by a hearing device with directional microphones, while the dashed line HVO shows a maximum possible compensation for hearing loss when using omnidirectional microphones. Depending on the type of hearing device, the two lines are positioned between 5 and 10 dB apart. This means that a greater amplification is possible with omnidirectional microphones than with directional microphones.

The diagram in FIG. 5 shows a typical hearing curve HK of a hard-of-hearing person. The hearing curve HK intersects the line HVD at a cut-off frequency GF. The point of intersection specifies the range above which, for stability reasons, hearing loss compensation is no longer possible using directional microphones. In the example shown, the cut-off frequency is around 2 kHz.

In order now to obtain the benefit of directional microphones, the signal components above the cut-off frequency GF are transposed to low frequencies at which the hearing loss of the hard-of-hearing person is correspondingly lower. This means that the range marked “a” in FIG. 5 is accordingly transposed down to the range marked “b”. The amplification of directional microphones, which was limited on account of feedback, consequently no longer plays a limiting role.

The method described in the exemplary embodiments can be implemented by implementing corresponding software in a control unit of a hearing device.

### LIST OF REFERENCE CHARACTERS

1 Hearing device housing
2 Microphone
3 Signal processing unit
4 Receiver/loudspeaker
5 Battery
10 Directional microphone unit
11 First microphone
12 Second microphone
13 Delay unit
14 Inverter
15 First adder
16 Frequency transposition unit
17 Signal processing and amplification unit
18 Second adder
a Range above the cut-off frequency GF
b Range below the cut-off frequency GF
GF Cut-off frequency
HK Hearing curve
HVD Maximum hearing loss that can be assisted with directional microphones
HVO Maximum hearing loss that can be assisted with omnidirectional microphones
R1 First microphone signal
R2 Second microphone signal
RA Signal with directional characteristic
RAV Frequency-transposed signal with directional characteristic
S Sound signal from the side/from the rear
SU Microphone sum signal
SUV Amplified and processed microphone sum signal
T1 Time 1
T2 Time 2
V Sound signal from the front

1.-9. (canceled)

10. A method for operating a hearing device, comprising:
emitting at least two omnidirectional microphone signals from at least two omnidirectional microphones of the hearing device;
electrically connecting the at least two omnidirectional microphones one another to form a signal with directional characteristic; and
decreasing a signal component of the signal with directional characteristic above a cut-off frequency down to a frequency range below the cut-off frequency by a signal processing unit of the hearing device.

11. The method as claimed in claim 10, wherein the signal component is transposed down to the frequency range below the cut-off frequency.

12. The method as claimed in claim 10, wherein the signal component is compressed down to the frequency range below the cut-off frequency.

13. The method as claimed in claim 10, wherein the signal component is added to the signal with directional characteristic before final amplification.

14. The method as claimed in claim 10, wherein the signal component is added to at least one of the omnidirectional microphone signals before final amplification.

15. The method as claimed in claim 10, wherein the cut-off frequency is a frequency at which a hearing curve of an audiogram attains a maximum compensatable hearing loss with a directional microphone mode.

16. A hearing device, comprising:
at least two omnidirectional microphones that emit at least two omnidirectional microphone signals and are electrically connected to one another to form a signal with directional characteristic; and
a signal processing unit that decreases a signal component of the signal with directional characteristic above a cut-off frequency down to a frequency range below the cut-off frequency.

17. The hearing device as claimed in claim 16, wherein the signal processing unit transposes the signal component down to the frequency range below the cut-off frequency.

18. The hearing device as claimed in claim 16, wherein the signal processing unit compresses the signal component down to the frequency range below the cut-off frequency.

19. The hearing device as claimed in claim 16, further comprising an adder that adds the signal component to the signal with directional characteristic before final amplification.

20. The hearing device as claimed in claim 16, further comprising an adder that adds the signal component to at least one of the omnidirectional microphone signals before final amplification.

21. The hearing device as claimed in claim 16, wherein the signal processing unit determines the cut-off frequency and the cut-off frequency is a frequency at which a hearing curve of an audiogram attains a maximum compensatable hearing loss with a directional microphone mode.

22. A computer program product executable in a signal processing unit of a hearing device for operating the hearing device, comprising:
processing at least two omnidirectional microphone signals by the signal processing unit, wherein the at least two omnidirectional microphone signals are emitted from at least two omnidirectional microphones of the hearing device that are electrically connected to one another to form a signal with directional characteristic; and
decreasing a signal component of the signal with directional characteristic above a cut-off frequency down to a frequency range below the cut-off frequency by the signal processing unit.

23. The computer program product as claimed in claim 22, wherein the signal component is transposed down to the frequency range below the cut-off frequency.

24. The computer program product as claimed in claim 22, wherein the signal component is compressed down to the frequency range below the cut-off frequency.
